(19) United States
(12) Patent Application Publication
(10) Pub. No.: US 2026/0354293 A1
(43) Pub. Date: Nov. 12, 2026

(54) Agricultural Machine Monitoring

(71) Applicant: AGCO International GmbH, Neuhausen (CH)

(72) Inventor: Ramon Buchaca Tarragona, Randers (DK)

(21) Appl. No.: 19/128,569

(22) PCT Filed: Sep. 12, 2023
(86) PCT No.: PCT/IB2023/059033

§ 371 Date: May 9, 2025

(30) Foreign Application Priority Data
Nov. 21, 2022 (GB) 2217370.2

(51) Int. Cl. A01B 69/00; A01B 76/00; B60R 1/26; B60R 1/28

(52) U.S. Cl. CPC A01B 69/001; A01B 76/00; B60R 1/26; B60R 1/28

(57) ABSTRACT

A system for monitoring operation of an agricultural machine. The system includes a camera and a control system which is configured, in use, to determine, within image data received from the camera, a position of an implement moveably coupled to the agricultural machine. A representation of the image data is then generated based on the position of the implement within the image.

### CROSS-REFERENCE TO RELATED APPLICATIONS

Not applicable.

### FIELD

Embodiments of the present disclosure relate generally to systems and methods for monitoring operation of an agricultural machine, and in particular for sensing arrangements for monitoring implements operably coupled to an agricultural machine.

### BACKGROUND

Transporting agricultural machinery, such as harvesting machines (e.g. combine harvesters) typically includes transporting associated implements and other machinery therewith. For instance, harvesters may be transported with a header trailer coupled to a rear of the combine for towing a header. Whilst this allows for the machines and associated implements to be transported by road, due to the size (length) of such headers, and therefore the associated trailers, this towing operation can be difficult.

Typically, an operator would rely on the side mirrors of the combine to view the trailer. However, again due to the length of such trailers the end of the trailer typically lies outside of the field of view of the side mirrors, particularly at larger turning angles. This significantly reduces the situational awareness of the operator, particularly during maneuvering the machines, e.g. into/out of fields, along narrow roads/streets, etc. In some systems, the operator may be able to make use of a rear facing camera to view behind the machine. However, known systems typically include low resolution cameras with fields of view which are still too small to view entire the trailer and all turning angles.

It is therefore an aim of the present disclosure to at least partially address one or more problems associated with the known solutions discussed herein.

### BRIEF SUMMARY

In an aspect of the invention there is provided a system for monitoring operation of an agricultural machine, comprising: a camera; and a control system, the control system comprising one or more controllers, and being configured, in use, to: receive image data from the camera; determine, within the image data, a position of an implement moveably coupled to the agricultural machine; and generate for display a representation of image data captured by the camera in dependence on the determined position of the implement within the image data.

Advantageously, the system of the present disclosure is able to determine a position of the implement within the image data and control the generated representation in dependence thereon. This may be used to, for example, only show a portion of the captured image relevant to the position of the implement, or to adjust the field of view of the camera in some manner to redirect the field of view on the basis of the determined position. This may increase situational awareness for the operator. In an example, a normally rear facing camera may be adjusted, or the image therefrom cropped or otherwise adjusted to display a generated representation which is left or right of a longitudinal axis of the machine/implement combination based on the location of the implement within the image.

The control system may be configured to utilise an object recognition algorithm to identify the implement within the image data and determine the position of the implement therefrom. The object recognition algorithm may comprise a trained model, trained utilising training data. The object recognition algorithm may be configured to identify, within the image data, an outline corresponding to the expected size and shape of one or more implements coupled to the machine. The control system may be configured to perform an initialization process to determine a starting location for the implement within the image data. The initialization process may include controlling generation of a request for an operator of the machine to confirm the presence of an implement within the image data. The initialization process may comprise generating a request for an operator to identify the implement within the image data. This may include controlling output of a control signal to a user interface of or otherwise associated with the machine for interaction by the operator.

The control system may be configured to track movement of the implement within the image data. The generated representation may then be adjusted in dependence on the tracked movement. Advantageously, the generated representation may change during use to maintain the position of the implement within the representation, for example as the machine/implement combination performs a maneuver, which may include multiple different turning angles and hence movement of the coupled implement with respect to the machine.

The control system may be configured, in use, to identify within the image data a fiducial marker positioned on or otherwise associated with the implement. The control system may be configured to determine the position of the implement within the image data in dependence on the identified fiducial marker. The system may comprise the fiducial marker.

The control system may be configured to generate and output one or more control signals for a user interface of or otherwise associated with the agricultural machine for display of the generated representation of the image data. The user interface may comprise a display terminal of the agricultural machine. The user interface may comprise a screen of a portable user device, such as a tablet computer or smart phone, for example. The system may comprise the user interface.

The control system may comprise an input for receiving an input signal indicative of a user input relating to the generated representation. For example, the user input may correspond to a desired format for the representation, to show or hide the representation, or to change a field of view of the generated representation. Where present, the user input may be provided via the user interface. For example, the user interface may comprise one or more user operable buttons, which may be physical buttons or soft buttons provided on a touch screen or the like, for example.

The control system may be configured to generate, as part of the generated representation, one or more indicators within the representation. The one or more indicators may comprise one or more lines, for example. The one or more lines may correspond to a centre line or longitudinal axis of the machine. This may provide additional awareness to the operator of the position of the implement with respect to the machine.

The camera may comprise a moveable camera. A moveable camera may comprise a camera where the optical arrangement of the camera may be moved relative to the machine to change the field of view of the camera. This may include cameras whereby the optical arrangement may be moved or controlled relative to a housing of the camera. Alternatively, the system may comprise a camera having an arrangement to control the position of the entire camera unit about one or more axes. This may effectively provide a camera which can be rotated about said one or more axes to adjust the field of view. The control system may be configured to control movement of the camera, or the optical arrangement thereof in the manner discussed herein in dependence on the determined position of the implement.

The control system may be configured to generate the representation in dependence on a selected portion of image data obtained by the camera. The selection of the portion of image data may be dependent on the determined position of the implement within the image data. For example, the control system may select a portion of image data corresponding to the determined position of the implement, for example such that the implement is positioned substantially centrally within the selected portion of the image data. The control system may select one from a set of predetermined portions of image data (e.g. a left and right view) in dependence on the implement being determined to be within the left hand or right hand side of the image data.

The control system may be configured to generate the representation from a virtual position within the image data. The location of the virtual position may be determined in dependence on the determined position of the implement within the image data. The virtual position may be, for example, displaced from the actual position of the camera to provide (virtually) a different viewpoint of the implement compared with the actual line of sight from the point of view of the camera. The control system may be configured to apply one or more image transformations to the image data in generation of the representation in dependence on the location of the virtual position. Advantageously, the one or more image transformations may correct/rectify image distortion due to the translation to the virtual position.

The system may include two or more cameras. In such embodiments, the control system may be configured to obtain image data from each of the two or more cameras; determine, within the image data, a position of an implement moveably coupled to the agricultural machine; and generate for display a composite representation of image data captured by one or more of the cameras in dependence on the identified position of the implement within the image data. The composite representation of the image data may comprise or be generated in dependence on image data from multiple cameras. The control system may be configured to stitch or otherwise combine the image data from the multiple cameras to generate the composite representation. Where the implement is determined to be positioned within a field of view of one of the cameras, the control system may be configured to generate the composite representation utilising the image data from that camera only, or from multiple cameras of the two or more cameras.

The one or more controllers of the control system may be provided as part of a control unit of the camera.

The one or more controllers may collectively comprise an input (e.g. an electronic input) for receiving one or more input signals. The one or more input signals may comprise the image data. The one or more controllers may collectively comprise one or more processors (e.g. electronic processors) operable to execute computer readable instructions for controlling operational of the control system, for example, to determine position of the implement within the received image data and/or to generate the representation of the image data. The one or more processors may be operable to generate one or more control signals for controlling operation of one or more operational components of the agricultural machine, for example a user interface, for controlling display of the generated representation of the image data. The one or more controllers may collectively comprise an output (e.g. an electronic output) for outputting the one or more control signals.

A further aspect of the invention provides a control system for monitoring operation of an agricultural machine, the control system comprising one or more controllers, and being configured to: receive image data from a camera on or otherwise associated with agricultural machine; process the received image data to determine, within the image data, a position of an implement moveably coupled to the agricultural machine; and generate and output one or more control signals for controlling the display of a representation of image data captured by the camera via a user interface of or otherwise associated with the agricultural machine in dependence on the determined position of the implement within the image data.

The control system may comprise any one or more of the same features and/or be configured in the same manner as the control system of the system of the preceding aspect.

Another aspect of the invention provides an agricultural machine comprising the system and/or comprising or being controllable by the control system of any preceding aspect.

The agricultural machine may comprise a harvesting machine, such as a combine harvester or a forage harvester, for example. The implement may comprise a header trailer moveably coupled to the harvesting machine, which may or may not have a header mounted or otherwise positioned thereon.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a simplified cross-sectional side view illustrating a harvester embodying aspects of the present disclosure;

FIG. 2 further illustrates the harvester of FIG. 1 having a trailer coupled thereto;

FIGS. 3A and 3B are top down schematic views illustrating the operational use of aspects of the present disclosure;

FIG. 4 is a schematic view of an embodiment of a system of the present disclosure; and

FIGS. 5A and 5B are images illustrating the operational use of aspects of the present disclosure.

### DETAILED DESCRIPTION

The present disclosure relates, in general, to a system 60, control system 100 and an agricultural machine, illustrated here in the form of a combine harvester 10, comprising the system 60 and control system 100. Image data from a camera 35 mounted or otherwise coupled to the rear of the combine 10 is processed to determine the position of an implement, here a header trailer 50 coupled via hitch point 40 to the combine 10. With knowledge of the position of the trailer 50, the control system 100 is configured to generate a representation of image data from the camera 35 for display to an operator of the combine 10, here via a user interface in the form of a display terminal 30 of the combine 10, in the manner discussed herein.

### Combine

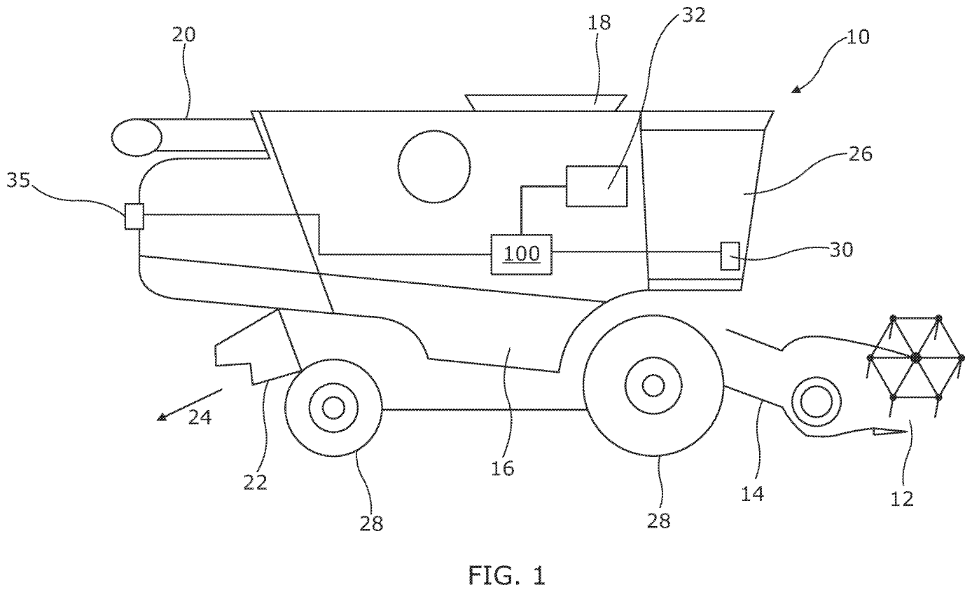

FIG. 1 illustrates an agricultural machine, and specifically a combine 10, embodying aspects of the present invention.

In this Figure, combine 10 is coupled to a header 12 which is operable, in use, to cut and gather a strip of crop material as the combine 10 is driven across a field or region to be harvested during a harvesting operation. A conveyor section 14 conveys the cut crop material from the header 12 into a crop processing apparatus 16 operable to separate grain and non-grain (i.e. material other than grain (MOG), typically straw and chaff) as will be appreciated. It is noted here that apparatus for separating grain and non-grain material are well-known in the art and the present invention is not limited in this sense. The skilled person will appreciate that numerous different configurations for the crop processing apparatus may be used as appropriate. Clean grain separated from the cut crop material is collected in a grain bin 18, which may be periodically emptied, e.g. into a collection vehicle, storage container, etc. utilising unloading auger 20.

The remaining material, made up largely of non-grain material or MOG, is separately moved to a spreader tool 22 which is operable in use to eject the material from the rear of the combine 10 and onto the ground. In FIG. 1, arrow 24 illustrates the direction of the material being ejected rearwards from the combine 10.

The spreader tool 22 includes an inlet (not shown) into which material is passed from one or more further components of the combine 10. This may include material from a chopper tool provided as part of the crop processing apparatus. The spreader tool 22 additionally includes an outlet through which the material is deposited from the combine 10 and onto the field/region being harvested by the combine 10. Rotor units may be provided as part of the spreader tool 22 for providing a propulsive force for propelling the material from the spreader tool 22 and out of the combine 10. For instance, the rotor units may each include a plurality of blades which interact with the material to propel the material through an outlet of the spreader tool 22, and the speed of rotation of the rotor units may be controlled (or may be set at a predetermined level) for controlling the propulsive force provided to the material—i.e. the speed at which the material is propelled from the combine 10.

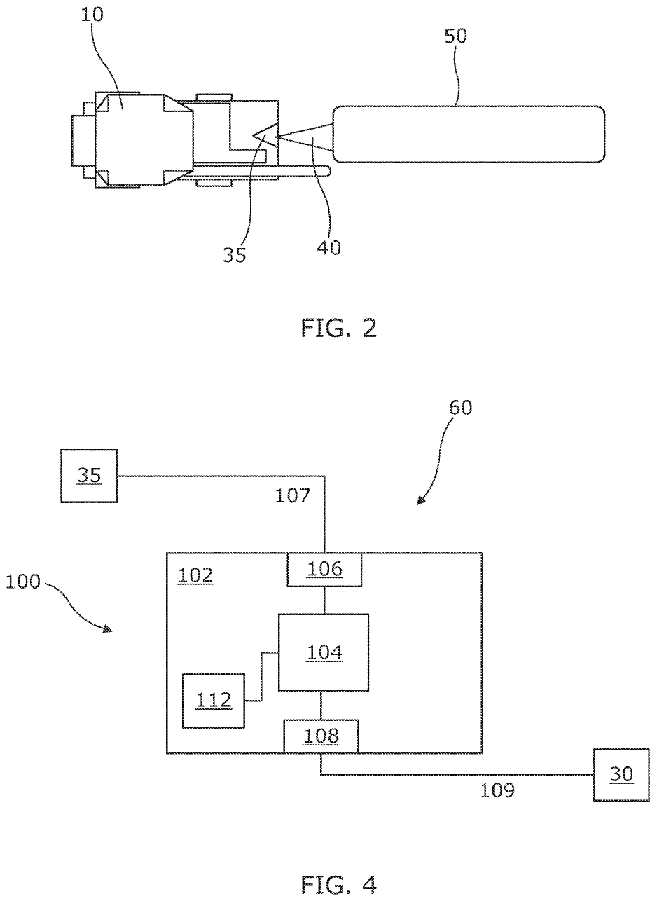

The present disclosure relates to the use of a camera 35 positioned facing rearwards of the combine 10 and operable to be used to monitor an implement coupled to a rear hitch point 40 of the combine 10. Here, this comprises a header trailer 50 for carrying, for example, header 12 for transportation when not in use, for example when travelling on road. This is illustrated in FIG. 2, where header trailer 50 is coupled via rear hitch 40 at the rear of the combine 10.

### Operational Use

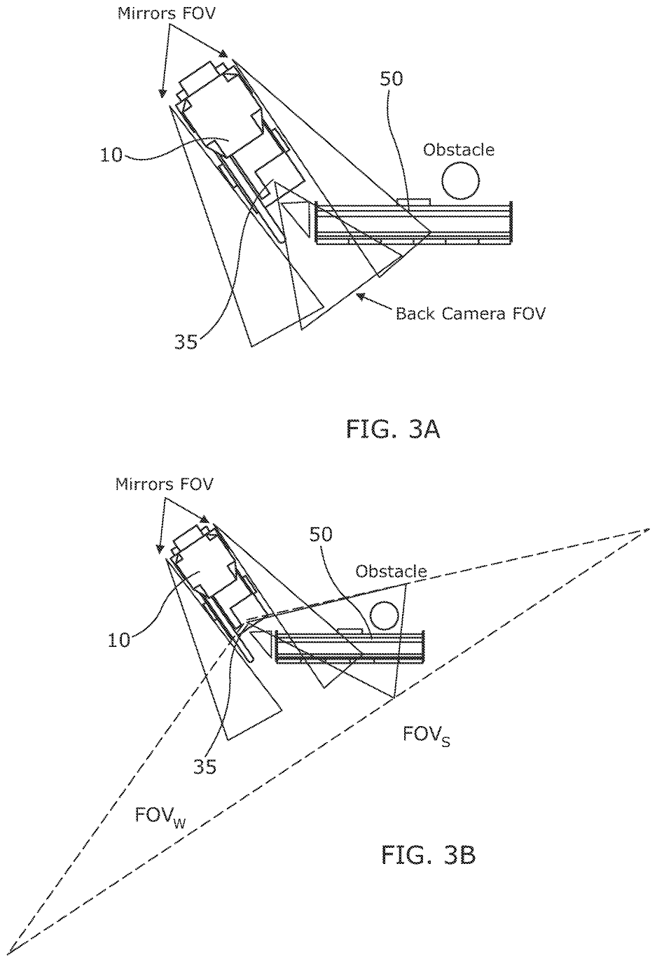

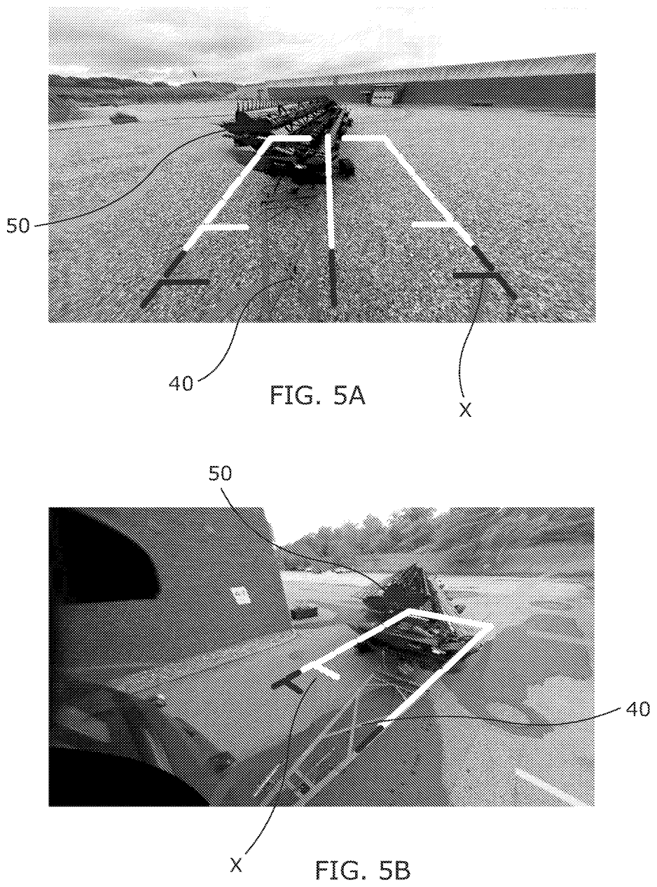

The operational use of aspects of the present disclosure is now described with reference specifically to FIGS. 3A, 3B, 5A and 5B.

As discussed herein, the present invention utilises image data from the camera 35 to determine the location of the trailer 50 within the image data, and hence with respect to the combine 10. This data is advantageously used to control generation of a representation of the image data for display, for example by the user terminal 30 of combine 10 to assist the operator of the combine 10 when towing the trailer 50 in this manner.

FIG. 3A illustrates a problem associated with known systems whereby a camera with a fixed or narrow field of view is used to monitor the trailer 50. At sufficiently large turning angles, such as that shown in FIG. 3A, the distal end of the trailer 50 is shown outside of both the field of view of the camera 35 and also the rear facing side mirrors of the combine 10. This can make maneuvering the combine 10 plus trailer 50 combination difficult. Furthermore, obstacles, such as the obstacle shown in FIG. 3A effectively becomes invisible to the operator of the combine 10.

The present disclosure provides means to mitigate this issue and better assist the operator. Specifically, image data from the camera 35 is used to determine the position of the trailer 50. This information is then used to generate a representation of the image data for display to an operator. In effect, the field of view of the camera 35, or at least the field of view of the generated representation is selected based on the determined position of the trailer 50 such that as much of the trailer 50 is present within the displayed representation as possible. As discussed in detail herein, generation of the representation may be performed in a number of ways.

FIG. 3B figuratively illustrates the adjusted field of view of the generated representation. In this illustrated embodiment, it is determined from the received image data that the trailer 50 is angles to the right hand side of the combine 10, typically because of a turn being performed by the combine 10. The present disclosure therefore utilises this information to generate a representation of the image data which is effectively angled with respect to the rear of the combine 10 to encompass the position of the trailer 50. In this way, both the distal end of the trailer 50 and also the obstacle are present within the displayed representation, thereby increasing the situational awareness of the operator of the combine 10 when compared with the prior art solution demonstrated by FIG. 3A. Specifically, a selected region FOVs of the field of view of the camera 35 is chosen from the whole field of view FOVw of the camera 35. It is the selected region FOV, and the image data used therefrom to generate the displayed representation.

Turning to FIGS. 5A and 5B, these show image data from the camera 35, and how the present disclosure selects, for display, a portion of the image data depending on the identified location of the trailer 50 within the image data. Here, camera 35 comprises a wide angle field of view in the region of 180 degrees. This may be commonly referred to as a fish eye camera, or an equivalent. The raw image data from such an arrangement can be severely distorted, however suitable processing of the image data can render the representation shown in FIGS. 5A and 5B.

In this illustrated example, the trailer 50 is, in FIG. 5A substantially directly behind the combine 10. The system 60 and specifically the control system 100 as described herein is configured to determine the location of the trailer 50 from analysis of the image data and then select the portion of the image data containing the trailer 50 for display to an operator of the combine 10. In FIG. 5A, this is a substantially central portion of the larger, wider image obtained by camera 35. However, in FIG. 5B, the trailer 50 is in the location shown in FIGS. 3A and 3B and hence a different portion of the larger image is selected for display to the operator to maintain the trailer 50 within the displayed representation of the image.

An extension of the present disclosure is also illustrated in these Figures. In particular, each of the representations shown in FIGS. 5A and 5B incorporate visible indicia in the form of reference lines X for use by the operator. The reference lines X include a centre line illustrating the longitudinal axis of the combine 10, side lines illustrating the width of the combine 10 with respect to the displayed image and an end stop, illustrating the distance between the edge of the image and the near end of the trailer 50 when directly behind the combine 10. These reference lines X are utilised to provide additional context to the displayed representation as the angle of the generated representation (with respect to the combine 10) changes, in use. In particular, an operator of the combine 10 is able to determine utilising these reference lines the respective hitch angle of the combine 10 and trailer 50.

### Control System

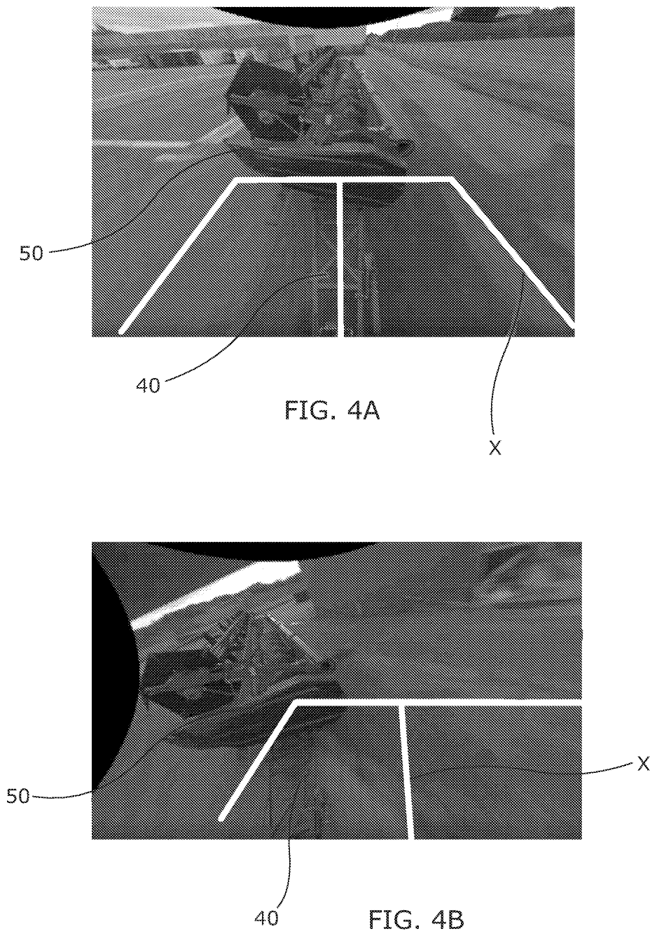

FIG. 4 is a schematic illustration of an embodiment of a control system 100 in accordance with the invention, and its functionality within a wider system 60 for agricultural machines (e.g. combine 10). As discussed herein, the control system 100 is operable to control generation of a representation of image data obtained by a camera 35 mounted or otherwise coupled to the combine 10 in dependence on a determined location of an implement, and specifically here a trailer 50 within the image data.

Here, the control system 100 comprises a controller 102 having an electronic processor 104, an electronic input 106, an electronic output 108 and memory 112. The processor 104 is operable to access the memory 110 and execute instructions stored therein to perform given functions in the manner described hereinabove, and ultimately generate and output a control signal 109 from output 108 for controlling display by a user interface, in the form of a display terminal 30 of the combine 10, following analysis of image data from camera 35.

In the illustrated embodiment, the processor 104 is operable to receive image data from the camera 35. The impact data is provided via a communication channel between a communication unit of the camera 35 and the electronic input 106 of the controller 102, specifically in the form of input signals 107 received at electronic input 106 of controller 102.

Processor 104 is operable to analyse the image data to determine therefrom a position of an implement coupled to the combine 10, specifically a trailer 50 coupled at the rear hitch 40 of the combine 10, within the image data. This may include the processor performing an object recognition algorithm of the received image data to identify the trailer 50 and the corresponding pixel positions of the trailer 50 in the image data. In an extension of this, the processor 104 may utilise a user input, e.g. at user terminal 30, indicative of the location of the trailer 50 in determining the location of the trailer in the image data. For example, it may be advantageous to request, from an operator, an indication of the trailer 50 in the wider image as an initialization step. This may speed up the initial recognition of the trailer 50. Identification of the trailer may include assigning a bounding box about the trailer in the image data. The position/pixel values for the bounding box may be used to determine the field of view of the generated representation—e.g. by centering the bounding box in the generated representation.

Once the position of the trailer 50 within the image data has been identified, the processor is configured to control generation of a representation of the image data in dependence on the determined position of the trailer 50. The control signals 109 are output via electronic output 108 to a local control unit associated with the display terminal 30 of the combine 10 for display of the generated representation.

As discussed herein, in the illustrated embodiment, the control system 100 and specifically the processor 104 thereof is configured to generate the representation in dependence on a selected portion of image data obtained by the camera 35. Specifically, the processor 104 is configured to generate the representation utilising image data corresponding to a selected region which encompasses the determined position of the trailer 50 within the image.

In an extension of the illustrated system 60, the control system 100 may be configured to generate the representation from a virtual position within the image data. The location of the virtual position may be determined in dependence on the determined position of the trailer 50 within the image data. Advantageously, the control system 100 may be configured to generate a representation from the point of view of a virtual observer within the image data to better illustrate the position of the trailer 50 with respect to the combine 10.

In an alternative arrangement, camera 35 may instead comprise a moveable camera which is moveably mounted via a rig to the combine 10. Rather than select a portion of the image data received from the camera in dependence on the determined position of the trailer 50, the control system 100 may in this alternative be configured to generate control signals for controlling operation of the rig to control movement of the camera about one or more axes. This may make it possible for the camera, and hence the displayed field of view, to be rotated on the basis of the determined position of the trailer 35. This may allow for a comparatively simpler camera arrangement for the system 60 with a lower processing requirement compared with wide angle camera 35, or embodiments which incorporate the possibility of generation of a virtual image.

In yet a further extension, the control system 100 may be configured to identify within the image data a fiducial marker positioned on or otherwise associated with the trailer 35. The marker may be used in place of the object detection algorithm to identify the position of the trailer 35 within the image data in dependence on the identified fiducial marker. Whilst this may reduce processing complexity of the system 60, an operator would be required to mount the marker on the implement prior to use. However, this may be a more cost effective solution.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

1. A system for monitoring operation of an agricultural machine, comprising:
a camera; and
a control system, the control system comprising one or more controllers, and being configured, in use, to:
receive image data from the camera;
determine, within the image data, a position of an implement moveably coupled to the agricultural machine; and
generate for display a representation of image data captured by the camera in dependence on the determined position of the implement within the image data.

2. A system as claimed in claim 1, wherein the control system is configured to utilize an object recognition algorithm to identify the implement within the image data and determine the position of the implement therefrom.

3. A system as claimed in claim 1, wherein the control system is configured to perform an initialization process to determine a starting location for the implement within the image data.

4. A system of claim 1, wherein the control system is configured to generate the representation from a virtual position within the image data; wherein the location of the virtual position is determined in dependence on the determined position of the implement within the image data.

5. A system of claim 4, wherein the control system is configured to apply one or more image transformations to the image data in generation of the representation in dependence on the location of the virtual position.

6. A system as claimed in claim 1, wherein the control system is configured to:
track movement of the implement within the image data; and
adjust the generated representation in dependence on the tracked movement.

7. A system as claimed in claim 1, wherein the control system is configured, in use, to:
identify within the image data a fiducial marker positioned on or otherwise associated with the implement; and
determine the position of the implement within the image data in dependence on the identified fiducial marker.

8. A system as claimed in claim 1, wherein the control system is configured to generate and output one or more control signals for a user interface of or otherwise associated with the agricultural machine for display of the generated representation of the image data.

9. A system as claimed in claim 8, wherein the user interface comprises: a display terminal of the agricultural machine; or a portable user device.

10. A system as claimed in claim 1, wherein the control system comprises an input for receiving an input signal indicative of a user input relating to the generated representation.

11. (canceled)

12. A system of claim 1, wherein the camera comprises a moveable camera; and the control system is configured to control movement of the camera in dependence on the determined position of the implement.

13. A system of claim 1, wherein the control system is configured to generate the representation in dependence on a selected portion of image data obtained by the camera, the selection of the portion of image data being dependent on the determined position of the implement within the image data.

14. A system of claim 1, comprising two or more cameras; and wherein the control system is configured to:
obtain image data from each of the two or more cameras;
determine, within the image data, a position of an implement moveably coupled to the agricultural machine; and
generate for display a composite representation of image data captured by one or more of the cameras in dependence on the identified position of the implement within the image data.

15. A control system for monitoring operation of an agricultural machine, the control system comprising one or more controllers, and being configured to:
receive image data from a camera on or otherwise associated with agricultural machine;
process the received image data to determine, within the image data, a position of an implement moveably coupled to the agricultural machine; and
generate and output one or more control signals for controlling the display of a representation of image data captured by the camera via a user interface of or otherwise associated with the agricultural machine in dependence on the determined position of the implement within the image data.

16. (canceled)

17. (canceled)
